(19) United States
(12) Patent Application Publication
(10) Pub. No.: US 2007/0077406 A1
(43) Pub. Date: Apr. 5, 2007

(54) Photocatalytic coating

(76) Inventors: Jeffry L. Jacobs, Stillwater, MN (US); Mark T. Anderson, Woodbury, MN (US); James G. Carlson, Lake Elmo, MN (US); Carol-Lynn Spawn, Stillwater, MN (US); Rachael A. T. Gould, Forest Lake, MN (US)

Correspondence Address: 3M INNOVATIVE PROPERTIES COMPANY, PO BOX 33427, ST. PAUL, MN, 55133-3427, US

(21) Appl. No.: 11/240,316

(22) Filed: Sep. 30, 2005

(51) Int. Cl. B32B 3/26; B32B 9/00

(52) U.S. Cl. 428/304.4; 428/318.4

(57) ABSTRACT

In one embodiment, the present application is directed to a structure. The structure comprises a structural layer having an external surface and a coating on the external surface of the structural layer. The coating comprises a polyurethane binder; and photocatalytic particles within the polyurethane binder. In another embodiment, the present application is directed to a composition. The composition comprises a polyurethane binder and photocatalytic particles within the polyurethane binder.

### FIELD

The present invention is directed to photocatalytic coatings, for example coatings used on construction surfaces like roofing.

### BACKGROUND

Photocatalytic coatings are used in, for example, the construction industry. Roofing substrates, for examples tiles and shingles.

Discoloration of roofing substrates and other building materials due to algae infestation has become especially problematic in recent years. Discoloration has been attributed to the presence of blue-green algae, Gloeocapsa spp., transported through air-borne particles. Additionally, discoloration from other airborne contaminants, such as soot and grease, contribute to discoloration.

In order to combat the discoloration, photocatalytic materials have been added to roofing substrates and shingles. One example includes photocatalytic titania, which in the presence of ultraviolet light (sunshine) will photo-oxidize the organic materials causing the discoloration.

Currently, no photocatalytic algae-resistant roof tile products are prevalent on the market. Some products claim to provide microbial protection for up to 7 years, such as those products sold under the tradename DUR-A-SHIELD Antimicrobial Surface Protection (acrylate polymer with an anti-microbial agent), available from Dur-A-Shield International, Inc. (Palm Coast, Fla.). These products rely on antimicrobial agents that weather and lose effectiveness over time. The acrylate is also subject to degradation over time by UV light. The effectiveness of such coatings has yet to be proved on a large scale.

The general approach to combat discoloration of roofs is periodic washing. This can be done with a high-power water washer. Also sometimes bleach is used in areas where micro-organism infestation is particularly bad. Having a roof professionally washed is a relatively expensive, short-term approach to algae control. The use of bleach can cause staining of ancillary structures and harm surrounding vegetation.

### SUMMARY

It is desirable to have a phototcatalytic coating for a structural layer, for example, asphalt shingles, roofing granules or a concrete or clay tile, or other roofing substrate that will maximize the exposure of the photocatalytic material. Additionally, it is desired to have photocatalytic technology that has the potential to keep surfaces clean for over five years, thus obviating the need for periodic cleaning.

While prior art has taught binders highly or totally resistant to photodegradation, the current invention utilizes binders that undergo slow but significant photodegradation catalyzed by the photocatalytic particles. It has been found that this provides effective algicidal properties while maintaining acceptable outdoor exposure lifetimes.

In one embodiment, the present application is directed to a structure. The structure comprises a structural layer having an external surface and a coating on the external surface of the structural layer. The coating comprises a polyurethane binder; and photocatalytic particles within the polyurethane binder.

In another embodiment, the present application is directed to a composition. The composition comprises a polyurethane binder and photocatalytic particles within the polyurethane binder.

### DETAILED DESCRIPTION

The coating composition of the invention comprises a polyurethane binder and photocatalytic particles. Polyurethane binder systems provide the preferred level of photostability. The composition may comprise additional additives. Examples of such additives include, but are not limited to, pigments, dyes, colorants, surfactants, UV stabilizers, crosslinkers and antioxidants.

The polyurethane binder described in this application comprises the reaction product of one or more polyisocyanates with one or more polyols and optional additional isocyanate reactive and non-reactive components. The reaction may be promoted by catalysts and solvents may be used as reaction media. In certain embodiments, the polyurethane binder is substantially aliphatic. A substantially aliphatic polyurethane is made from an aliphatic isocyanate.

The polyurethane binder may be waterborne, but solvent borne or 100% solids versions are also sufficient. Suitable waterborne urethane binders may be prepared by methods known to the art and may include added surfactants, catalysts and cosolvents. 100% solids polyurethane binders may be formed by combining polyisocyanates with polyols, catalysts and other components and casting and curing in place. Examples of waterbome polyurethane binders are polycarbonate and polyester based polyurethanes available from Stahl USA under the tradename PERMUTHANE. Crosslinkers and other waterborne auxiliaries that are effective in the invention with these polyurethane binders are also available from Stahl USA, also under the tradename PERMUTHANE. Some waterbome urethane binders may contain pendant dispersing groups such as carboxyl or sulfonate. Examples of sulfonated waterbome polyurethane binders are described in U.S. Pat. No. 6,649,727 assigned to 3M Company.

The polyurethane binder may be crosslinked through various methods including the reactions of carbodiimides, aziridines, polyisocyanates, polyvalent metal ions, or pendant siloxane groups.

For the purpose of the present application, the term “Polyisocyanates” means any organic compound that has two or more reactive isocyanate (i.e. —NCO) groups in a single molecule. Generally, the polyisocyanates can be aliphatic diisocyanates. Examples include isophorone diisocyanate available from Bayer Corporation under the tradename DESMODUR I, hexamethylene diisocyanate, 4,4′-methylenebiscyclohexane diisocyanate commonly referred to as “H₁₂MDI” and sold under the tradename DESMODUR W by Bayer Corporation, trimethyl 1,6-hexamethylene diisocyanate available under the tradename TMDI from Degussa Corporation, and similar materials.

For the purpose of the present application, the term “Polyol” refers to polyhydric alcohols containing two or more hydroxyl groups and includes diols, triols, tetraols, etc. Preferred polyols are aliphatic polyester diols, aliphatic polycarbonate diols, and silicone diols. Examples of each category include polycaprolactone polyols available from Dow Chemical Co., polyhexamethylene carbonate polyols available from Stahl USA, and silicone diols available from Crompton Corporation. A preferred class of polyols for use in the current invention are diols having a molecular weight of from about 200 to about 3000. Generally, the polyols used are mixtures of polyols containing both higher molecular weight polyols having a molecular weight from about 200 to about 3000 with lower molecular weight diols such as ethylene glycol, 1,4-butanediol, 1,3-propanediol and the like. Polyols having functionality higher than 2 are also useful, generally in a mixture with diols.

In certain embodiments, the polyol is a polycarbonate polyol. A polycarbonate polyol is a polyol having hydroxyl terminal groups and comprising carbonate linkages. A specific example is a polycarbonate diol prepared from hexanediol and having the following structure: HO-[CH2CH2CH2CH2CH2CH2—OC(═O)O-]nCH2CH2CH2CH2CH2CH2-OH wherein n ranges from 1 to about 20. Analogous polycarbonate diols prepared from diols other than hexanediol, are also effective, as are polycarbonate diols prepared from mixtures of diols.

In one embodiment, the polyurethane binder system described in this application is a silane terminated urethane dispersion. Binder systems in this family are described in U.S. Pat. Nos. 5,554,686; 6,313,335; 3,632,557; 3,627,722; 3,814,716; 4,582,873; 3,941,733; 4,567,228; 4,628,076; 5,041,494; and 5,354,808, herein incorporated by reference. These binder systems contain a high fraction (˜40-50%) of non-silicon organic components.

The polyurethane binder may be, for example, in an aqueous dispersion of polyurethane compositions terminated by hydrolyzable and/or hydrolyzed silane groups and containing ionic solubilizing or emulsifying groups. In some examples, the silane group includes alkoxy silane groups, chloro silane groups and the like. Generally, emulsifying groups are carboxyl groups or sulfonate groups.

Photocatalytic Particles

Photocatalysts, upon activation or exposure to sunlight, establish both oxidation and reduction sites. These sites are capable of preventing or inhibiting the growth of algae on the substrate or generating reactive species that inhibit the growth of algae on the substrate. In other embodiments, the sites generate reactive species that inhibit the growth of biota on the substrate. The sites themselves, or the reactive species generated by the sites, may also photooxidize other surface contaminants such as dirt or soot or pollen. Photocatalytic elements are also capable of generating reactive species which react with organic contaminants converting them to materials which volatilize or rinse away readily. Photocatalytic particles conventionally recognized by those skilled in the art are suitable for use with the present invention. Suitable photocatalysts include, but are not limited to, TiO₂, ZnO, WO₃, SnO₂, CaTiO₃, Fe₂O₃, MoO₃, Nb₂O₅, TiₓZr₍₁₋ₓ₎O₂, SiC, SrTiO₃, CdS, GaP, InP, GaAs, BaTiO₃, KNbO₃, Ta₂O₅, Bi₂O₃, NiO, Cu₂O, SiO₂, MoS₂, InPb, RuO₂, CeO₂, Ti(OH)₄, combinations thereof, or inactive particles coated with a photocatalytic coating. In other embodiments, the photocatalytic particles are doped with, for example, carbon, nitrogen, sulfur, fluorine, and the like. In other embodiments, the dopant may be a metallic element such as Pt, Ag, or Cu. In some embodiments, the doping material modified the bandgap of the photocatalytic particle. In some embodiments, the transition metal oxide photocatalyst is nanocrystalline anatase TiO₂.

Relative photocatalytic activities of a coated substrate may be determined via a rapid chemical test that provides an indication of the rate at which hydroxyl radicals are produced by UV-illuminated photocatalyst in or on the substrate. One method to quantify the production of hydroxy radicals produced by a photocatalyst is through use of the ‘terephthalate dosimeter’ which has been cited numerous times in the open literature. Recent publications include: “Detection of active oxidative species in TiO2 photocatalysts using the fluorescence technique” Ishibashi, K; et. al. Electrochem. Comm. 2 (2000) 207-210. “Quantum yields of active oxidative species formed on TiO2 photocatalyst” Ishibashi, K; et al. J. Photochem. and Photobiol. A: Chemistry 134 (2000) 139-142.

In the test, a coated substrate of known area containing particles is placed in the bottom of a 500 mL crystallization dish. To the dish is added 500 g of 4×10⁻⁴ M aqueous disodium terephthalate solution. Agitation is provided by a magnetic stirring bar placed in the bottom of a submerged small Petri dish. The small Petri dish serves to prevent possible abrasion of the coating by the stirring bar, resulting in suspended particles that could lead to erroneous activity readings. The large crystallizing dish is placed on a magnetic stirrer under a bank of UV lights consisting of 4, equally spaced, 4 ft. (1.2 m) long black light bulbs (Sylvania 350 BL 40W F40/350BL) powered by two specially designed ballasts (Action Labs, Inc., Woodville, Wis.) to increase the intensity of emitted light. The height of the bulbs was adjusted to provide ˜2.3 mW/cm² UV flux. Light Flux was measured using a VWR (Westchester, Pa.) UV Light Meter (Model 21800-016) equipped with a UVA Radiometer model UVA365 and a wide band wavelength of 320-390 nm. During irradiation, approximately 3 mL of the solution is removed at approximately 5 minute intervals with a pipet and transferred to a disposable 4-window polymethylmethacrylate or quartz cuvette. The sample in the cuvette is placed into a Fluoromax-3 spectrofluorimeter (SPEX Fluorescence Group, Jobin Yvon, Inc. Edison, N.J.). The fluorescence intensity of the sample at λₑₓ 314 nm, λₑₘ 424 is plotted versus sample irradiation time. The fluorescence intensity vs. time plots for different coating formulations can be plotted in the same figure for comparison. The slope of the linear portion of the curves (slope of the initial 3-5 datapoints) is indicative of the relative photocatalytic activity of different coating formulations; this test is referred to herein as the Initial Slope TPA method. Baseline activity is measured by running this test on the aqueous disodium terephthalate solution without particles.

Generally, results of photocatalytic coatings containing particles are at least two times the baseline measurement. In certain embodiments, results of the photocatalytic coatings containing particles are at least 50 times the baseline measurement, and in specific embodiments, the photocatalytic coatings containing particles are at least 100 times the baseline measurement.

Optionally, other rapid chemical tests, such as the photobleaching of organic dyes can also be used as indicators of relative photoactivities of coated substrates.

Optionally, the coating composition comprises pigments, dyes, colorants, surfactants,. UV stabilizers, crosslinkers, and antioxidants to make a sufficient coating.

Structural Layers

The structural layer may be any layer, especially those used in construction. For example, the structural layer may be an interior or exterior construction surface. A construction surface is a surface of something man-made. The structural layer may be horizontal, for example a floor, a walkway or a roof, or vertical, for example the walls of a building. For the purpose of the present application, the term “vertical” includes all non-zero slopes.

The material forming the structural layer may be internal or external. The structural layer may be porous or dense. Specific examples of structural layers include, for example, concrete, clay, ceramic (e.g. tiles), natural stone and other non-metals. Additional examples of the structural layer include roofs, for example metal roofs, roofing granules, synthetic roofing materials (e.g. composite and polymeric tiles) and asphalt shingles. The structural layer may also be a wall.

The coatings of the invention provide long-term resistance to staining from bio-organisms or from airborne contaminants. In the presence of UV light, for example from sunshine, the photocatalytic titania in the coatings photo-oxidizes organic materials. For example, it oxidizes materials such as volatile organic compounds, soot, grease, and micro-organisms; all of which can cause unsightly discoloration.

The coatings of the invention also can “fix” or oxidize nitrogen oxides from the air and thus reduce the amount of one component responsible for poor outdoor air quality.

The coatings can also make surfaces easier to clean with water, as they oxidize the N, P, and S in compounds to soluble ions that can be washed away with rain or another water source.

The following examples further disclose embodiments of the invention.

### EXAMPLES

In the following examples, materials not specifically identified with a supplier were obtained from Sigma-Aldrich Chemicals.

### Example 1

A prepolymer was made in a 0.5-L reaction flask equipped with a heating mantle, condenser, stirring blade, nitrogen inlet and thermometer. The prepolymer was prepared from a mixture of 50.71 g (0.4562 eq.) of isophorone diisocyanate (IPDI, tradename DESMODUR I, available from Bayer Corporation), 76.71 g (0.0600 eq.) of a silicone polyether copolymer diol (Eq. Wt. 1278, from Dow Coming, Midland, Mich.), 76.04 g (0.0273 eq.) of a silicone polyether copolymer diol (Eq. Wt. 2787, from Dow Coming), 6.88 g (0.1026 eq.) of 2,2-bis(hydroxymethyl) propionic acid (DMPA, available from GEO Specialty Chemicals, Allentown, Pa.) and 45.0 g of n-methyl pyrrolidinone (NMP) cosolvent. The mixture was heated with stirring to 60° C. Approximately 0.152 g of dibutyl tin dilaurate was added, and the mixture was heated to 80° C. and allowed to react for 6 hours. Finally, 39.65 g (0.0382 eq.) of TERATHANE-2000 (a poly(tetramethylene ether glycol) of 1000 average equivalent weight, available from INVISTA, Wilmington, Del.) was added; the mixture was maintained at 80° C. overnight. The heat was then turned off and the mixture was stirred for one hour during cooling, resulting in the prepolymer.

A premixture was made with 293.93 g of distilled water, 2.79 g of triethylamine, 3.19 grams (0.1062 eq) of ethylene diamine and 2.53 g (0.0133 eq.) DYNASYLAN 1110 (N-methylaminopropyltrimethoxysilane, available from Degussa). 160.0 g of the prepolymer, was added over 10 minutes to the premixture in a Microfluidics Homogenizer (Model #HC-5000, available from Microfluidics, Newton, Mass.) at an airline pressure of 0.621 MPa, resulting in a stable silane-terminated urethane dispersion (STUDS).

### Example 2

### Preparation of STUDS/Titania Coating Composition and Coated Concrete Roof Tile

32 g of Ishihara ST-01 anatase titania (available from Ishihara Sangyo Kaisha Ltd) was mixed with 90 g of the STUDS suspension from Example 1, and 20 g of water, to make a 50 wt % solids slurry. A foam brush was used to apply approximately 23 g of the slurry to a 12″×16″ concrete roofing tile. The coating was allowed to dry in air, resulting in a white appearance. The coated tile was placed alongside an uncoated control tile, and subjected to natural weathering at a 3M outdoor weathering facility in Houston, Tex. The cleanliness of the tiles was evaluated at 6-month intervals; the control tile exhibited dark staining while the coated tile showed no visible discoloration after 4.5 years, whereas the control tile already showed visible discoloration after 2.5 years.

### Example 3

### Alternative Preparation of STUDS Dispersion

A prepolymer was made in a 0.5-L reaction flask equipped with a heating mantel, condenser, stirring blade, nitrogen inlet and thermometer. The prepolymer was prepared from a mixture of 60.73 g (0.5461 eq.) of isophorone diisocyanate (IPDI), 133.58 g (0.1045 eq.) of a silicone polyether copolymer diol (Eq. Wt. 1278), 8.24 g (0.1228 eq.) of 2,2-bis(hydroxymethyl) propionic acid (DMPA) and 45.0 g of n-methyl pyrrolidinone (NMP) cosolvent. The mixture was heated with stirring to 60° C., approximately 0.152 g of dibutyl tin dilaurate was added, and the mixture was heated to 80° C. and allowed to react for 6 hours. Finally, 47.47 g (0.0457 eq.) of TERATHANE-2000 was added, and the mixture was heated at 80° C. overnight. The heat was turned off and the mixture was stirred for one hour during cooling, resulting in a prepolymer.

A premixture was made with 300.0 grams of distilled water, 6.26 g of triethylamine, 3.81 g (0.1267 eq) of ethylene diamine and 3.03 g (0.0158 eq.) of DYNASYLAN 1110. 160.0 g of the prepolymer was added over 10 minutes to the premixture, in a Microfluidics Homogenizer (Model #HC-5000, available from Microfluidics, Newton, Mass.) at an air line pressure 0.621 MPa, resulting in a stable silane-terminated urethane dispersion (STUDS).

### Example 4

### Preparation of Pigmented STUDS/Titania Coating Composition

The STUDS dispersion from Example 3 was used to prepare coating mixtures incorporating a titania photocatalyst. Pigment and surfactant were added to the STUDS/titania mixture to provide color coating dispersions. The combination was shear mixed to improve homogeneity and, in some cases, also provided a thixotropic coating material. The coating material tended to settle over a span from minutes to hours, but could be re-suspended with simple shaking. The colored coating dispersions were applied to an aluminum substrate and color and contact angle was measured.

Samples in Table 1 were prepared by mixing in a 40 mL scintillation vial, 3.96 g STUDS (density˜1 g/cc, ˜30 wt % solids), 0.88 g water, 0.10 g surfactant (sodium tetradecylsulfate), 0.132 g iron oxide yellow pigment (Mapico 3100, available from Rockwood Pigments, Princeton, N.J.), and 1.32 g titania powder as listed in the following table. The combination was shear-mixed for 2-3 minutes with an Omni International GLH homogenizer (available from Omni International, Marietta, Ga.) equipped with a ˜1 cm diameter head.

TABLE 1
Coating Suspensions and Coated Substrates Properties

| | | | | | Static | |
|---|---|---|---|---|---|---|
| | | | | | Water | |
| | | | | | Contact | |
| Sam- | | | | | angle | |
| ple | Titania | L* | a* | B* | (°) | Comments |
| 1 | Tayca¹ | 76.51 | 9.89 | 24.59 | 86.3 | Excellent |
| | TKP-102 | | | | | suspension; |
| | | | | | | even coatings |
| 2 | Ishihara² | 71.78 | 12.45 | 37.78 | 149.4 | Excellent |
| | ST-01 | | | | | suspension; |
| | | | | | | even coatings |
| 3 | CPM³ | 72.8 | 13.75 | 33.39 | 112.3 | Nice suspension; |
| | A1-1 | | | | | slightly dewet |
| | | | | | | on substrate |
| 4 | Kronos- | 80.27 | 8.54 | 24.62 | 81.7 | Nice suspension; |
| | 1000⁴ | | | | | uniform coating |
| 5 | FCI- | 76.63 | 11.61 | 33.52 | 141.5 | Good suspension; |
| | 030403B⁵ | | | | | mixed easily |
| 6 | Control - | 61.47 | 17.5 | 55.16 | 112.5 | |
| | no titania | | | | | |

¹Tayca Corp., Okayama, Japan
²Ishihara Sangyo Kaisha Ltd, Osaka, Japan
³CPM Industries, Inc., Wilmington, DE
⁴Kronos Inc., Cranbury, NJ
⁵First Continental Industries (NJ) Inc., Newark, NJ

Approximately 3.4 mL of each dispersion was coated with a #46 Meyer rod onto a 196 cm² aluminum substrate. The target wet thickness was 83 μm; the target dry thickness was approximately 34 μm or 1.4 mils. Color measurements were made on a HunterLab Labscan XE (HunterLab, Reston, Va.). The color at two positions on each sample was measured, and the data were averaged.

Static water contact angles were measured with a VCA video contact angle instrument (available from AST Products, Inc., Billerica, Mass.) using a 5μL droplet. The contact angle at three positions on the sample was measured, and the data were averaged.

As shown in Table 1, the type of titania has a large influence on the rheology of the suspension, the stress within the coatings, and the initial contact angle and color. The titania generally makes the coatings lighter; also, the contact angle is more difficult to predict and likely depends on both the surface properties of the titania and its distribution in the coating.

### Example 5

### Silane Terminated Urethane and Simple Urethane Compositions

A series of coating compositions were formulated to compare using urethane dispersions which contain silicon to urethane dispersions that are silicon free. Four samples were prepared in this example. For two of the samples, the STUDS formulation from Example 3 was used as the binder. For the other two, commercial polyurethane waterborne dispersions, RU41-268 and RU40-415, available from Stahl Corporation were used as the binder. RU-40-415 is a lightfast, colloidal, waterborne, polycarbonate-urethane dispersion. It provides a tough medium hard film, and is known for superior hydrolytic stability and excellent long-term weathering. RU-41-268 is a waterborne aliphatic urethane dispersion. In this example, it was combined at 10% by weight with a water dilutable activated multifunctional polycarbodiimide crosslinking agent, XR-5500, also from Stahl.

The four samples for this example were prepared by shear-mixing the reagents listed in Table II in 40-mL scintillation vials to form a dispersion (2-3 minutes using an Omni International GLH rotor-stator mixer equipped with an ˜1-cm diameter head). Approximately 2 mL of each dispersion was coated with a Meyer rod as described in Table 2, onto a 196 cm² aluminum substrate. The excess was pushed off the sides of the substrate by the Meyer rod.

TABLE 2
Formulations for Samples

| binder | titania type | titania (g) | wet binder (g) | water (g) | ethanol (mL) | pigment (g) | SDS (g) |
|---|---|---|---|---|---|---|---|
| STUDS | | 3.145 | 12.807 | 3.659 | 16.000 | 0.314 | 0.100 |
| STUDS | Ishihara ST-01 | 3.145 | 12.807 | 3.659 | 16.000 | 0.314 | 0.100 |
| RU41-268 | Ishihara ST-01 | 1.57 | 5.49 | 1.83 | 4.40 | 0.16 | 0.05 |
| RU40-415 | Ishihara ST-01 | 1.57 | 6.40 | 1.83 | 4.95 | 0.16 | 0.05 |

Note:
Samples were coated at ˜0.23 mils with #18 Meyer rod. STUDS density ˜1.0 g/cc, 30 wt % solids; pigment is red iron oxide 115M (available from Bayer); SDS is sodium dodecyl sulfate. The RU40-415 binder was combined at 10% by weight prior to preparation of the coating solution with a water dilutable activated multifunctional polycarbodiimide crosslinking agent, XR-5500, also from Stahl.

For each of the samples the, contact angle, photocatalytic activity, scratch performance, and color were measured at 0 h and after 500 h of accelerated weathering.

Color measurements were made on a HunterLab Labscan XE. The color at two positions on each sample was measured and the data were averaged. Static water contact angles were measured with an AST Products, Inc VCA video contact angle instrument using a 5 μL droplet. The contact angle at three positions on the sample was measured and the data were averaged. A Nicolet infrared spectrometer (available from Nicolet, Madison, Wis.) was used to analyze the coating composition using a small amount of the coating scraped off for the analysis. The Initial-Slope TPA method was used to determine the relative photocatalytic activity of the samples. The scratch rating was determined by scraping a foam applicator across the sample. A rating of 5 indicates a wide scratch track extending all the way to the substrate approximately as wide as the applicator; a rating of zero indicates no visible scratch; a rating of 1 indicates a very thin <1 mm line.

The samples were aged for 500 h using an accelerated weathering protocol, ASTM G155, which includes a sunlight simulator and periodic water spray. The samples were removed and examined again with the above techniques.

Table 3 shows the measured initial contact angles (average of 3 readings) of the samples, and the apparent contact angle after 500 h, as observed by placing a drop of water on the weathered sample. After 500 h, the control contact angle (without any titania) remains high.

For all the Stahl polyurethane samples after 500 h, the water droplet spreads and the contact angle is assumed to be near zero. Spreading of the droplet is consistent with decomposition of the binder, at least at the surface of the coating (as measured by infrared spectroscopy).

TABLE 3
Contact Angles at 0 h and 500 h accelerated weathering

| Sample | 0 h AVE CA | 500 h CA |
|---|---|---|
| STUDS control | 106.7 | 100 |
| STUDS/Ishihara ST-01 | 144.1 | 0 |
| RU41-286/Ishihara ST-01 | 70.0 | 0 |
| RU40-415 + XR-5570/Ishihara ST-01 | 70.8 | 0 |

The results indicate that it is possible to obtain the desirable very low contact angles (hydrophilicity) with urethane/titania systems both in which the urethane has silane functionality and also in which the urethane is silicon free.

Table 4 shows that the titania containing samples (regardless of binder) have significant photocatalytic activity—both before and after weathering—compared to the control, which has negligible activity. The data also shows after 500 h of accelerated weathering, a nearly two-fold increase in activity for the STUDS/titania sample and a 4- to 6-fold increase in activity for the Stahl urethane/titania samples.

TABLE 4
TPA Measurements at 0 h and 500 h accelerated weathering

| Sample | 0 h TPA | 500 h TPA |
|---|---|---|
| STUDS control | 0 | 0 |
| STUDS/Ishihara ST-01 | 50733 | 101221 |
| RU41-286/Ishihara ST-01 | 38802 | 265166 |
| RU40-415 + XR-5570/Ishihara ST-01 | 53185 | 204951 |

Table 5 shows that after 500 h of accelerated weathering, the Stahl polyurethane/titania samples have unexpectedly good performance, even better than the STUDS control. This result combined with the TPA results described above, shows that it is possible to simultaneously achieve good photocatalytic activity and scratch performance for a system that includes an organic (polyurethane) binder.

TABLE 5
Scratch performance at 0 h and 500 h accelerated weathering

| Sample | abrasion after 500 h |
|---|---|
| STUDS control | 1 |
| STUDS/Ishihara ST-01 | 5 |
| RU41-286/Ishihara ST-01 | 0.5 |
| RU40-415 + XR-5570/Ishihara ST-01 | 0.5 |

Note:
Lower numbers indicate better performance: the scale roughly correlates with the scratch depth when the samples is tested with a standard abrasive tool, as described previously.

Table 6 lists the values for L*, a*, and b* at 0 h and 500 h of accelerated weathering. Note that the L* values generally increase and that the a* and b* values decrease after 500 h for all but the control.

TABLE 6
Color Measurements at 0 h and 500 h accelerated weathering

| | 0 h | | | 500 h | | | 500 h - Change | | |
|---|---|---|---|---|---|---|---|---|---|
| Sample | L* | a* | b* | L* | a* | b* | ΔL* | Δa* | Δb* |
| STUDS control | 63.64 | 13.19 | 10.55 | 66.41 | 12.35 | 11.59 | 2.77 | −0.84 | 1.04 |
| STUDS/Ishihara ST-01 | 60.31 | 22.37 | 18.76 | 66.33 | 21.15 | 14.95 | 6.02 | −1.22 | −3.81 |
| RU41-286/Ishihara ST-01 | 55.01 | 28.33 | 23.16 | 63.93 | 23.88 | 15.69 | 8.92 | −4.45 | −7.47 |
| RU40-415 + XR-5570/Ishihara ST-01 | 59.25 | 23.52 | 19.37 | 65.41 | 21.41 | 13.64 | 6.16 | −2.11 | −5.73 |

### Example 6

### Non-Silane Terminated Urethane Compositions

A series of coating compositions were formulated using urethane dispersions which were silicon free. The formulations were prepared to show that UV stabilizers can be incorporated into the coating formulation. The intent of the UV stabilizers is to mitigate the oxidation rate of the organic portions of the binder and reduce the rate at which the coatings “lighten”. The materials used in these compositions were:

| Name | Description | Source |
|---|---|---|
| Ru 21-075 | 35 wt % polycarbonate | Stahl USA, |
| | waterborne polyurethane | Peabody, MA |
| Ru 21-077 | 40 wt % no NMP polyester | Stahl USA, |
| | waterborne urethane | Peabody, MA |
| XR-5570 | Crosslinker | Stahl USA, |
| | | Peabody, MA |
| P-25 | Aeroxide TiO₂ | Degussa Corp. |
| | P-25 powder | Germany |
| Red pigment | 115M Red iron oxide | Bayer |
| | | New Martinsville, WV |
| Tinuvin 123 | UV protector | Ciba Specialty Chemicals Inc. |
| | | Basel, Switzerland |
| Tinuvin 765 | UV protector | Ciba Specialty Chemicals Inc. |
| | | Basel, Switzerland |

The 12 coating formulations listed Table 2 were produced in 2 oz. glass vials, charged with the specified amounts of the materials. If more then one material was used in the coating, the contents of the vial were then mixed to a homogeneous mixture using an IKA Turrax Disperser (model T18, available from Sigma Aldrich) at setting 4 for four minutes.

TABLE 2
Coating Formulations (weight of each
component listed is in grams)

| Sam- | Ru | Ru | XR- | | Pig- | Tinuvin | Tinuvin | Wa- |
|---|---|---|---|---|---|---|---|---|
| ple | 21-075 | 21-077 | 5570 | P25 | ment | 123 | 765 | ter |
| 1 | 10 | | | | | | | |
| 2 | 10 | | 0.7 | | | | | |
| 3 | 10 | | 0.7 | 0.875 | 0.26 | | | 5 |
| 4 | 10 | | 0.7 | 0.875 | 0.26 | 0.0437 | 0.0437 | 5 |
| 5 | 10 | | | 0.875 | 0.26 | 0.0437 | 0.0437 | 5 |
| 6 | 10 | | | 0.875 | 0.25 | | | 5 |
| 7 | | 10 | | | | | | |
| 8 | | 10 | 0.8 | | | | | |
| 9 | | 10 | 0.8 | 2.67 | 0.26 | | | 10 |
| 10 | | 10 | 0.8 | 2.67 | 0.26 | 0.0667 | 0.0667 | 10 |
| 11 | | 10 | | 2.67 | 0.26 | 0.0667 | 0.0667 | 10 |
| 12 | | 10 | | 2.67 | 0.26 | | | 10 |

Concrete tiles were prepared as a test substrate for the coatings. A 500 mL plastic beaker was charged with roughly 300 g. of concrete mix (Sand Mix product# 1103 from Quikrete of Atlanta, Ga.). The beaker was then charged with enough deionized water so at 10:1 concrete: water mixture was formed. The mixture was then stirred by hand using a wooden tongue depressor until the mixture looked uniform in wetness and no dry powder was visible. The mixture was then transferred and packed into a 100×15 mm square plastic Petri dish (from Becton Dickson Labware of Franklin Lakes, N.J.). Then the concrete was flattened so that it was even with the top of the Petri dish and excess concrete was removed. The tongue depressor was then used to gently press down on the top of the concrete to bring excess water to the surface and then the depressor was used to flatten and smooth the top of the concrete. This process was repeated until an adequate number of squares were produced. The squares were then laid on a flat surface and allowed to sit undisturbed overnight. The following day the concrete squares were removed from the Petri dishes and washed with water for 5 minutes. Then the concrete squares were placed vertically into a plastic tub with 0.5 inch spacing between each square and cold water was trickled into the tub for 24 hours.

A small amount (about a mL) of each coating sample was pipetted onto the surface of the concrete square then spread across the surface of the concrete using a 1-inch wide paintbrush. This process was repeated until an even coating was achieved on the surface of the concrete, after which the concrete square was placed on the counter top and allowed to air-dry overnight. The samples were then subjected to natural weathering at a 3M outdoor weathering facility in Houston, Tex. The cleanliness of the tiles being evaluated at 6-month intervals.

Various modifications and alterations of the present invention will become apparent to those skilled in the art without departing from the spirit and scope of the invention.

What is claimed is:

1. A structure comprising
a structural layer having an external surface; and
a coating on the external surface of the structural layer, the coating comprising
a polyurethane binder; and
photocatalytic particles within the polyurethane binder.

2. The structure of claim 1 wherein the polyurethane binder is silane terminated.

3. The structure of claim 1 wherein the polyurethane binder is silicon-free.

4. The structure of claim 1 wherein the polyurethane binder is aliphatic.

5. The structure of claim 1 wherein the polyurethane binder comprises a polycarbonate polyol.

6. The structure of claim 1 wherein the structural layer is porous.

7. The structure of claim 1 wherein the structural layer is formed from concrete.

8. The structure of claim 1, wherein the structural layer is formed from clay.

9. The structure of claim 1 wherein the structural layer is formed from ceramic.

10. The structure of claim 1 wherein the structural layer is a tile.

11. The structure of claim 1 wherein the structural layer is horizontal.

12. The structure of claim 1 wherein the structural layer is vertical.

13. The structure of claim 1 wherein the structural layer is a roof.

14. The structure of claim 13 wherein the structural layer is a metal roof.

15. The structure of claim 1 wherein the structural layer is a roofing granule.

16. The structure of claim 1 wherein the structural layer is an asphalt shingle.

17. The structure of claim 1 wherein the structural layer is a metal tile.

18. The structure of claim 1 wherein the structural layer is a polymeric roofing tile.

19. The structure of claim 1 wherein the structural layer is a wall.

20. The structure of claim 1 wherein the structural layer is an interior construction surface.

21. The structure of claim 1 wherein the structural layer is an exterior construction surface.

22. A composition comprising
a polyurethane binder; and
photocatalytic particles within the polyurethane binder.

23. The composition of claim 22 wherein the polyurethane binder is silane terminated.

24. The composition of claim 22 wherein the polyurethane binder is silicon-free.

25. The composition of claim 22 wherein the polyurethane binder is substantially aliphatic.

26. The composition of claim 22 wherein the polyurethane binder comprises a polycarbonate polyol.

27. The composition of claim 22 wherein the photocatalytic particles comprise a material selected from the group consisting of TiO₂, ZnO, WO₃, SnO₂, CaTiO₃, Fe₂O₃, MoO₃, Nb₂O₅, TiₓZr_{(1-x)O}₂, SiC, SrTiO₃, CdS, GaP, InP, GaAs, BaTiO₃, KNbO₃, Ta₂O₅, Bi₂O₃, NiO, Cu₂O, SiO₂, MoS₂, InPb, RuO₂, CeO₂, Ti(OH)₄, or combinations thereof.

28. The composition of claim 22 wherein the photocatalytic particles are doped.

29. The composition of claim 27 wherein the photocatalytic particles comprise photocatalytic titanium dioxide.

30. The composition of claim 22 wherein the photocatalytic particles are present in at least about 0.5% by volume dry basis.

31. The composition of claim 22 wherein the photocatalytic particles are present in at least about 1% by volume dry basis.

32. The composition of claim 22 wherein the photocatalytic particles are present in at least about 5% by volume dry basis.

33. The composition of claim 22 further comprising a pigment.

34. The composition of claim 33 wherein the weight ratio of the photocatalytic particles to the pigment in the composition is about 10:1.

35. The composition of claim 21 further comprising a surfactant.

36. The composition of claim 34 wherein the surfactant is present in less than about 2% by weight.

37. The composition of claim 22 wherein the silane terminated polyurethane comprises less than 50% silicone segments.
